(19) United States
(12) Patent Application Publication
(10) Pub. No.: US 2015/0120674 A1
(43) Pub. Date: Apr. 30, 2015

(54) VIRTUAL PROGRAM INSTALLATION AND STATE RESTORATION

(71) Applicant: NVIDIA Corporation, Santa Clara, CA (US)

(72) Inventors: Matthew J. Lavoie, Raleigh, NC (US); Yao-Tian Wang, East Palo Alto, CA (US); Scott Matloff, Dublin, CA (US)

(73) Assignee: NVIDIA Corporation, Santa Clara, CA (US)

(21) Appl. No.: 14/066,547

(22) Filed: Oct. 29, 2013

(51) Int. Cl. G06F 11/14; G06F 9/455

(52) U.S. Cl. CPC G06F 11/1446; G06F 9/45533
USPC 707/679

(57) ABSTRACT

The description is directed to systems and methods for restoring a program state retained from a prior execution session on a virtual machine. On receiving a request to execute a program an image of user-independent files are mounted to a virtual machine. Specified user-modifiable files are copied from a particular user storage location to put the program in a condition to execute the program so that it begins from the previously-existing program state. During the session at least some of the files are modified and on a session end the user-modifiable files are saved to the particular user storage location to retain the updated program state.

### BACKGROUND

Centralized computing platforms can be implemented to host and execute programs that are accessed via thin-client remote devices. The thin-client remote device performs only minimal processing (e.g., to send keystrokes to and receive rendered video output from the central platform), while the bulk of the processing to run the program is performed on the central platform. Such a setting is in some cases referred to as a cloud computing platform.

To run a program for a user, a virtual machine may be instantiated on the centralized platform, and the requested program may be installed on the virtual machine so that it can be executed by the virtual machine for the user. Program installation entails placing all of the files needed to execute the program into operating locations accessible by the virtual machine (e.g., copying files to logical drives of the virtual machine). This is typically accomplished by executing an often time-consuming setup program designed specifically for that program. The setup program copies files, updates OS settings, and establishes all other resources necessary for the execution of the program. When a user requests an execution session of a program that they previously accessed, the virtual machine must be prepared so that the state of the program matches the state existing at the end of the prior execution session. For example, in the case of a game where the user has achieved a particular achievement level, the program installation on the newly-instantiated virtual machine should reflect that level, so that gameplay resumes from the point where the user left off in the prior session. One approach to virtual machine installation includes a mass copy operation, in which all of the files needed to execute the program are copied from source locations to the operating location(s) used by the virtual machine. This operation is time consuming, expensive in terms of I/O, and can detract from the end-user experience, as the user must wait while the virtual machine is prepared.

### BRIEF DESCRIPTION OF THE DRAWINGS

FIG. 1 is a block diagram illustrating a server system configured to host programs for remote clients in accordance with the present disclosure.

FIG. 2 is a block diagram illustrating a process for mounting user-independent files to a virtual machine in accordance with the present disclosure.

FIG. 3 is a block diagram illustrating a process for copying and saving user-modifiable files to virtual machine operating locations in accordance with the present disclosure.

FIG. 4 is a block diagram illustrating the events of a program execution session in accordance with the present disclosure.

FIG. 5 is a flow chart of an illustrative method for setting up a program to execute on a virtual machine so that a previously-existing program state is restored.

### DETAILED DESCRIPTION

This description is directed to novel systems and methods for installing a program on a virtual machine so that it can be executed starting from a previously-existing program state. During a configuration stage, the program can be pre-analyzed to separate its files into two classes: user-independent files and user-modifiable files. User-independent files (herein referred to as “UI files”) are not specific to a particular user and are not changed/modified during execution of the program. During virtual machine installation to execute a program, these files are not copied from one location to another in order to make them accessible to the virtual machine. Instead, they reside in a static storage location which is referenced during installation. For example, the UI files can be implemented as a read-only image that can be mounted from the static storage location without copying the files themselves to any new location. By avoiding a time-consuming mass copy, the virtual machine installation of the program can be rapidly implemented in each instance.

The user-modifiable files (herein referred to as “UM files”) are program files that potentially may be modified during an execution session. The UM files are specific to a given user and reside in a storage location associated with that user (e.g., as implemented via user accounts). UM files can include anything that might change during the course of an execution session. In the case of a game, for example, the UM files could include data reflecting game progress, achievement levels, etc. During virtual machine installation, the UM files for the user are copied from the user's storage location to one or more operating locations used by the virtual machine, in contrast to the UI files, which are not copied from location to location.

In conjunction with other virtual machine installation operations, the mounting of the UI files and the copying of the UM files place the virtual machine in a condition where it can begin executing the program from the previously-existing program state. The execution session then proceeds, during which at least some of the UM files are modified. At session end, the UM files as modified are copied back into the user's storage location and the UI file image is unmounted. By avoiding copy operations on the UI files, the virtual machine can be set up, and state can be saved and restored, much more rapidly and efficiently. This is a significant benefit, particularly where the program is requested frequently by a large number of users, thereby necessitating a large number of dynamically changing virtual machines to accommodate the user sessions.

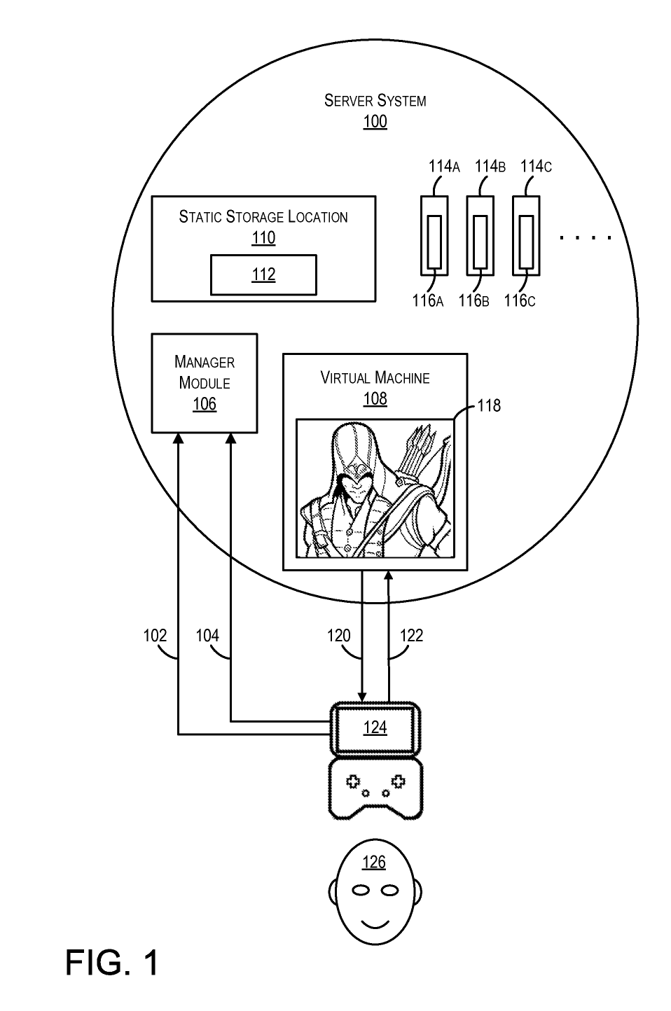

Turning now to the figures, FIG. 1 depicts a server system 100 configured to execute program 118 and allow user 126 to access the executing program using a remote computing device 124. The setting contemplates that the user will access the program repeatedly over time with each distinct occurrence being referred to as an execution session. In one example, server system 100 is implemented as a cloud gaming platform (i.e., program 118 is a game). The remote computing device in this example is a handheld gaming device which may run a thin client, such that the server system handles the large majority of the processing needed to execute the game. However, the server system and remote device may take on a wide range of configurations (i.e., other than a thin client accessing a cloud platform that runs a program). Similarly, program 118 need not be a game—the present description contemplates any type of software, including word processing, spreadsheets, photo-editing, CAD software, etc., to name but a few non-limiting examples.

As indicated above, files needed to execute program 118 may in general fall into two categories: UI files and UM files. UI files are not associated with any particular user, and they typically are not modified as a result of any user interaction with the program during an execution session. In many cases, the large majority of the files needed for program execution are these UI files. For example, UI files might constitute upwards of 90% of the total files that are used/needed for an execution session. The UI files may be stored as a read-only image, and the same UI files typically will be mounted for an execution session regardless of the user making the request.

UM files, on the other hand, include files needed to run program 118 and that potentially may be modified during a user's execution session. Each user typically has an associated set of UM files, i.e., User A will have an associated set of UM files that are different from the UM files associated with User B. Since the UM files for a user constitute the files that potentially will change throughout one or a series of execution sessions involving the user, they in one sense may be considered to represent all of the modifications to a clean install of the program that would make it functionally identical to the condition, or program state, of program 118 at the end of the prior execution session for the user. In the case of program 118 being a game, the program state represented by the UM files may include data such as game progress, achievements, user settings, custom content (such as texture files), etc., each of which typically is user specific. In order to maintain a set of UM files for each user, it is often advantageous to store them separately, from each other and from the UI files, as described below.

In the present example, server system 100 includes static storage location 110, multiple user storage locations 114A, 114B, 114C, etc., and a manager module 106. Static storage location 110 contains UI files 112, while the multiple user storage locations 114A, 114B, 114C, etc., contain a corresponding set of UM files 116A, 116B, 116C, etc. Each user typically has an associated user storage location, e.g., UM files for user 126 might be stored in location 114A, with the other user storage locations being allocated for different users/user accounts. By storing the UM files associated with each user in a particular user storage location, the system is able to restore the program state of a prior execution session to any device used by the user; thus enabling the transfer of games underway from one device to another. Also, it will be appreciated that different program states can be restored to the same device (in the case of different users using the same device).

In the case where server system 100 is a centralized hosting platform, it may be configured to transmit program outputs to the remote computing device, where the device may be a thin client that relies on the cloud-computing platform to handle the large majority of the computational demands needed to execute the program. In this case, program outputs 120 represent the result of the remote processing on the cloud platform, for example, rendered video output fed back to the thin client. Additionally, program inputs 122 may include activity information from a mouse, keyboard, button pad, joystick, audio-mic or other input device.

Although many examples herein refer to cloud-computing platforms, the concepts can be implemented in other settings with centralized program execution. To name one alternate example, the server system could be a corporate intranet where programs may be stored on a company server and employees or guest users could access those programs and coordinate their execution on the server via local clients (e.g., thin clients).

Manager module 106 is generally configured to manage instantiation and termination of virtual machines so that program states are properly restored and retained for users over multiple execution sessions. Operation of the manager module may be triggered by a request from a user to execute a program on the server platform. In response to the request, the manager module mounts the UI files associated with the program from the static storage location. A particular user storage location associated with the user who initiated the request can then be selected, and the UM files in that location can be copied to the appropriate operating locations of the virtual machine. With the UI and UM files being thus made accessible to the virtual machine, and other installation activities completed, the virtual machine is in a condition to execute the program in the current execution session so that execution begins from the previously-existing program state. The UM files are modified during the current execution session, and at the end of the session those files may be saved back to the particular user storage location in order to preserve the updated program state.

An execution session represents the interval between a user sending a request to the server system to execute a specific program and terminating the virtual machine created for that purpose. While the current execution session refers to any execution sessions currently active, a prior execution session may refer to any execution session that has been closed, typically the execution session closed most recently and associated with the same program and the same user. A subsequent execution session refers to a future execution session, typically the next execution session where the last updated program state will be restored in order to present a seamless experience for the user.

Execution sessions typically include three stages: a session start, a user operation stage and a session end. The session start of a current execution session is typically initiated with a user request, such as request 102, which may include user identification 104, to load and execute an application, such as program 118. Manager module 106 may respond by setting up virtual machine 108 so that it can appropriately access both the UI files and the UM files. In particular, the manager module 106 mounts UI files 112 from static storage location 110. It will be noted here that the UI files do not need to be copied from one location to another—they are simply mounted from the existing location in which they are stored. This greatly reduces the time and processing resources needed to set up the application for which execution has been requested. These time savings are particularly significant given that the UI files typically constitute the large majority of the files needed to execute the application.

The virtual machine setup also may include the manager module copying over the appropriate UM files so that those files are in an operating location that the virtual machine can use. For example, assume User A is associated with UM file set 116A. The manager module would then select that file set from sets 116A, 116B, 116C, etc., and copy that set from the associated storage location (e.g., user storage location 114A) to an operating location used by the virtual machine. The user identification 104 may be used by the manager module 106 to select the appropriate UM file set. The mounting of the UI files and copying of the UM files to the virtual machine operating location, among other things, places the virtual machine in a condition to execute the program beginning from a previously retained program state associated with the user's prior execution of the program. The above process can be described as a virtual installation of the program and a program state restoration.

The user operation stage represents the period where program outputs 120, including rendered video content, audio outputs and device instructions, are being sent to remote computing device 124 and program inputs 122, including keystrokes and peripheral inputs, are received from the device and used to manipulate program 118. As the program is manipulated, some or all of the UM files are modified.

The session end can be triggered by a user-action or an error, which may include program crashes and network errors. At this point the manager module typically takes the UM files reflecting the program state of the current execution session and compresses them into a state file, which is then saved back to the appropriate particular user storage location. Depending on the implementation, the state file may also include operating system settings associated with the virtual machine. As described in more detail below, the state file may also include metadata describing the operating locations used by the virtual machine for the UM files, in order to aid an extraction and copy process for a subsequent session.

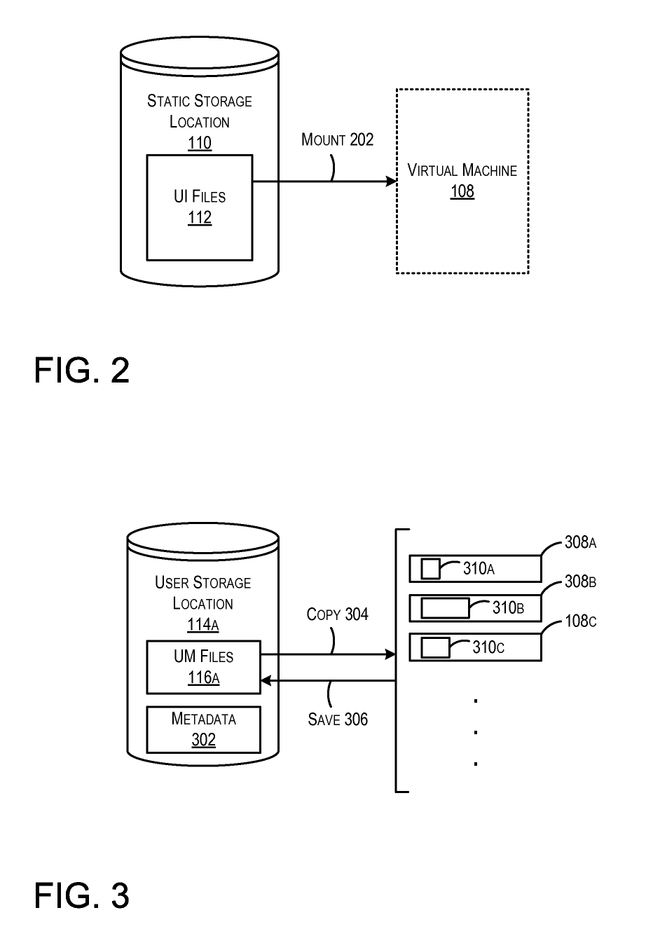

The mounting stage of the present disclosure is specifically depicted in FIG. 2. The diagram includes, from FIG. 1, the static storage location 110 which contains UI files 112, for example as a disk image. The UI files are mounted 202 to virtual machine 108 so that those files are usable by the virtual machine, for example as content on a logical drive of the virtual machine. In one respect, this mounting operation can be considered as part of a virtual machine installation, in which UI files needed to execute the program are installed by mounting a read-only disk image. And again, the mounted files are files for which it has been determined that the files are not associated with a particular user and are not modified as result of user-requested execution of the program. Instead, the static storage location typically is used by multiple different users and does not change between execution sessions. Also, in mounting 202, the UI files are not copied from one location to another, which reduces time lag between the user request and the execution of the program.

As discussed above, preparing for program execution after a user request also includes copying UM files from a user storage location (e.g., associated with a user's account) to one or more operating locations used by the virtual machine. FIG. 3 describes such a copy operation, but with an added feature in which the UM files for a particular user can be extracted and copied to multiple different operating locations based on metadata.

For a given set of UM files (e.g., set 116A from FIG. 1) retrieved from corresponding user storage location 114A, the UM files may include subgroup portions (e.g., portions 310A, 310B, 310C, etc.) that combine to form the full set of UM files 116A. Each portion corresponds to a particular operating location of the virtual machine, such as a logical drive used by the virtual machine. The files that are included in a UM subgroup portion and the operating location (e.g., logical drive) to copy each portion to may be described in metadata 302, which is typically stored along with the respective UM files in the respective user storage location. User state in the form of OS settings can be stored in other places (e.g. in the registry in the case of Windows®). For those cases, the state is extracted, and later restored like other user state which takes the form of files.

Copying 304 involves extracting UM files 116A, if compressed into a state file, and copying portions of the UM files from user storage location 114A to multiple virtual machine operating locations 308A, 308B, 308C, etc. in accordance with metadata 302. Specifically, in the case of multiple logical drives, the metadata would specify which portions are copied to which logical drives. At the end of the current execution session, the modified UM file groups are recombined and saved 306 back to the particular user storage location associated with the user to retain the program state information until the next session.

The examples described herein contemplate treating UI and UM files differently in order to more efficiently manage virtual machine operation so that program state is retained over multiple user sessions. Various methods may be employed, for a given program, in order to identify files as being either UI files or UM files. As indicated above, UM files are files that potentially will be modified over the course of an execution session. Pre-analysis of program operation may be used to identify the set of UM files. Specifically, the program can be run many times (e.g., thousands of times) or run in simulation to generate lists of files that have and that have not changed over the course of execution. Files can then be appropriately categorized and handled differently as discussed above. Alternatively, system tools are typically available that enable monitoring of file system read and write operations, and OS settings reads and writes. Output from such tools may inform the separation of UM and UI files.

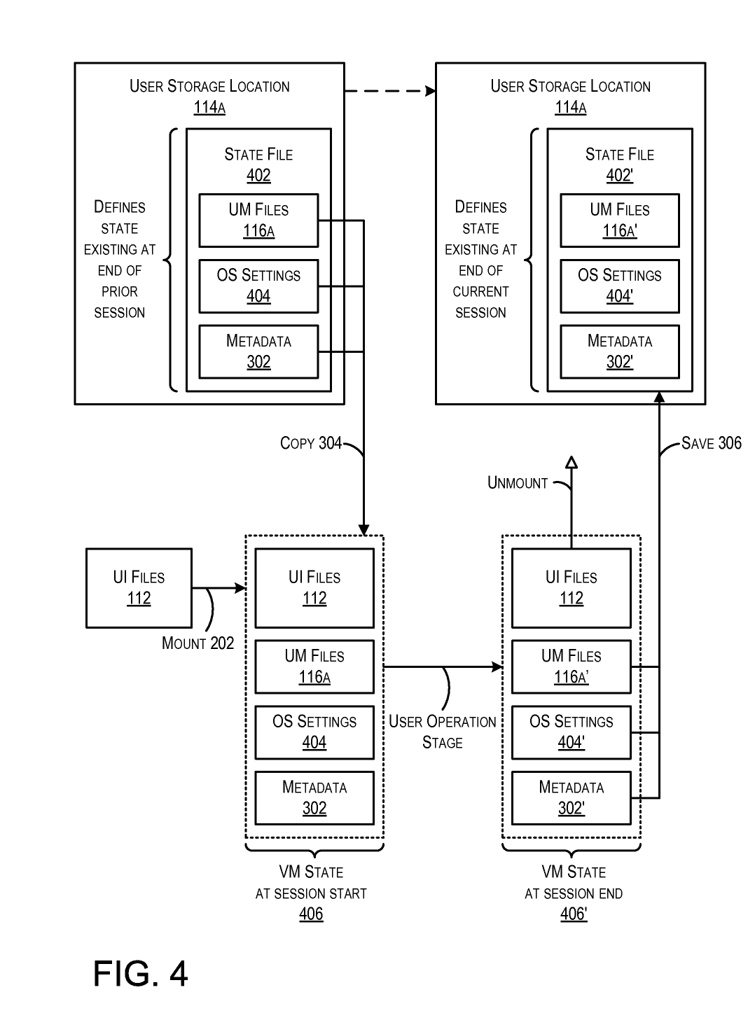

FIG. 4 illustrates a detailed example of an execution session demonstrating the inclusion of state file 402 to store the program and virtual machine states (also referred to as “VM states”). The state file is a compressed format containing UM files 116A (selected from 116A, 116B, 116C, etc. in FIG. 1), OS settings 404 and metadata 302, all of which are associated with a particular user and can be potentially modified as that user executes the program. The contents of the state file reflect some or all of the files necessary to restore program 118 to a previously existing program state, such as the UM files, and to restore the virtual machine to a previously existing virtual machine state, such as the OS settings. The state file may be compressed using any appropriate compression format/standard.

A session typically starts by mounting 202 UI files 112 and copying 304 state file 402 from user storage location 114A (selected from 114A, 114B, 114C, etc. in FIG. 1) to the virtual machine and extracting UM files 116A and OS settings 404. As previously discussed, metadata 302 may also be used to specify operating locations of the virtual machine to which the UM files are to be copied. The combination including the UI files, UM files, OS settings and metadata reflect a VM state at session start 406.

The program executes during the user operation stage. During this period, execution and other actions can produce modifications to the state of the program and virtual machine (UM files 116A can be modified to UM files 116A′, etc.). At the session end the modified state 406′ is retained by combining and compressing the modified files, typically including UM files 116A′, OS settings 404′ and metadata 302′, into state file 402′. The updated state file is saved 306 to the particular user storage location 114A, at which time it is available to aid in state restoration upon request for a subsequent execution session. The new state file may overwrite the previous state file representing the program state at the end of the prior execution session or, alternately, the previous state file may be preserved as a backup in case the updated state file is corrupted or otherwise unable to restore the program state as described. Finally, UI files 112 are unmounted and the virtual machine is terminated.

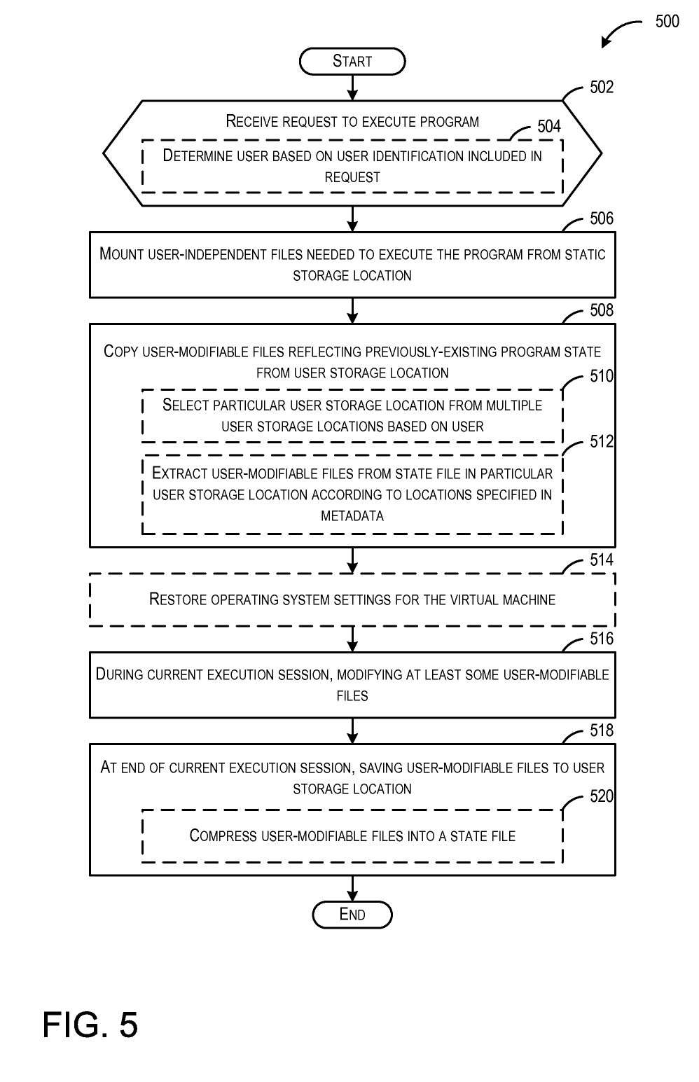

FIG. 5 depicts an exemplary method 500 for restoring, from a prior execution session of a program configured to execute on a virtual machine, a previously-existing program state of the program which was retained at the end of the prior execution session. At 502, method 500 includes receiving a user request to execute the program. In addition to or as part of the user request, and as shown at 504, a user identification may be provided in order to identify the user making the request. As described above, the request and identification may be provided from a thin-client remote computing device to a cloud-computing platform, though a variety of other configurations are possible. In response to the user request, method 500 includes mounting UI files needed to execute the program from a static storage location, as shown at 506. As discussed above, the mounting operation typically does not require UI files to be copied from one location to another. Instead, the static storage location and UI files typically are used by multiple different users of the program.

At 508, method 500 includes copying UM files reflecting a previously-existing program state from a user storage location. As shown at 510, the particular user storage location used in method 500 may be selected from multiple user storage locations based on the user requesting the program (e.g., based on the user identification provided at step 504). Method 500 optionally includes extracting UM files from a state file so that those files are placed in different operating locations of the virtual machine that are specified in metadata, as shown at 512. In addition, method 500 includes restoring operating system settings for the virtual machine, as shown at 514, effectively restoring the virtual machine to a previously-existing VM state.

During the current execution session, method 500 includes modifying at least some of the UM files, as shown at 516, representing a change in the program state. As discussed above, a wide range of modifications can occur during execution.

At the end of the current execution session, method 500 includes saving the UM files back to the user storage location associated with the requesting user, as shown at 518. Method 500 also optionally includes compressing the UM files into a state file for transit and storage, as shown at 520. If used, the state file may also include updated versions of the OS settings and the metadata associated with the UM files.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for restoring, from a prior execution session of a program configured to execute on a virtual machine, a previously-existing program state of the program which was retained at an end of the prior execution session, the method comprising:
receiving a request from a user to execute the program in a current execution session which follows the prior execution session;
in response to the user request, mounting, to the virtual machine, user-independent files needed to execute the program, where such user-independent files are mounted from a static storage location used by multiple different users and that does not change between execution sessions of the program;
in response to the user request, copying user-modifiable files from a user storage location associated with the user to at least one operating location used by the virtual machine, in order to place the virtual machine in a condition to execute the program in the current execution session so that execution begins from the previously-existing program state;
during the current execution session, modifying at least some of the user-modifiable files; and
at the end of the current execution session, saving the user-modifiable files as modified to the user storage location to preserve an updated program state.

2. The method of claim 1, where the request is received from a remote computing device and includes a user-identification that is usable to distinguish between multiple different users of the device, to thereby select the user storage location that is associated with the user.

3. The method of claim 1, where the user-modifiable files are saved back to the user storage location via compression into a state file.

4. The method of claim 3, where the state file includes metadata specifying where the user-modifiable files are to be copied to for a subsequent execution session, and where such specification includes that the files are to be copied to multiple different logical drives that are to be used by the virtual machine to execute the program in the subsequent execution session.

5. The method of claim 3, where the state file includes operating system settings that are to be restored for the virtual machine for use during a subsequent execution session.

6. The method of claim 1, further comprising, during the current execution session, sending program outputs from the virtual machine to a remote computing device and receiving, at the virtual machine, program inputs from the remote computing device.

7. The method of claim 6, where the virtual machine is implemented upon and accessible via a cloud-computing platform with which the remote computing device interacts.

8. The method of claim 1, further comprising configuring the virtual machine for a subsequent execution session by (a) copying the user-modifiable files as modified in the current execution session to the at least one operating location; and (b) mounting to the virtual machine the user-independent files from the static storage location, where such copying and mounting places the virtual machine in a condition to execute the program in the subsequent execution session so that execution begins from the updated program state.

9. The method of claim 1, where the saving of the user-modifiable files to the user storage location occurs upon one or more of a user-initiated execution session termination and an error-initiated session termination.

10. A server system configured to execute a program on a virtual machine and restore a previously-existing program state of the program which was retained at an end of a prior execution session, the server system comprising:
a static storage location for storing user-independent files needed to execute the program;
multiple different user storage locations, each being associated with one of multiple different users; and
a manager module configured to:
receive a request from one of the users to execute the program in a current execution session which follows the prior execution session;
in response to the request, mount, to the virtual machine and from the static storage location, the user-independent files;
select, from among the multiple different user storage locations, a particular user storage location associated with the user making the request;
copy user-modifiable files needed to execute the program from the particular user storage location to an operating location, in order to place the virtual machine in a condition to execute the program in the current execution session so that execution begins from the previously-existing program state; and
at the end of the current execution session, save the user-modifiable files as modified during the current execution session back to the particular user storage location to preserve an updated program state.

11. The server system of claim 10, where the request is received from a remote computing device and includes a user-identification that the manager module uses to distinguish between multiple different users of the device.

12. The server system of claim 10, where the user-modifiable files are saved back to the particular user storage location via compression into a state file.

13. The server system of claim 12, where the state file includes metadata specifying where the user-modifiable files are to be copied to for a subsequent execution session, and where such specification includes that the files are to be copied to multiple different logical drives that are to be used by the virtual machine to execute the program in the subsequent execution session.

14. The server system of claim 12, where the state file includes operating system settings that are to be restored for the virtual machine for use during a subsequent execution session.

15. The server system of claim 10, where the virtual machine is configured, during the current execution session, to send program outputs to a remote computing device and receive program inputs from the remote computing device.

16. The server system of claim 15, where the server system and virtual machine are implemented upon a cloud-computing platform that is accessed by the remote computing device to execute the program.

17. A method for restoring, from a prior execution session of a program configured to execute on a virtual machine, a previously-existing program state of the program which was retained at an end of the prior execution session, the method comprising:
receiving a request from a user to execute the program in a current execution session which follows the prior execution session;
in response to the user request, mounting, to the virtual machine, user-independent files needed to execute the program, where such user-independent files are mounted from a static storage location used by multiple different users and that does not change between execution sessions of the program;
copying user-modifiable files from a user storage location associated with the user to at least one operating location used by the virtual machine, in order to place the virtual machine in a condition to execute the program in the current execution session so that execution begins from the previously-existing program state, and where the copying includes extracting the user-modifiable files from a state file that includes metadata specifying where the user-modifiable files are to be copied to so that they are usable by the virtual machine to execute the program.

18. The method of claim 17, where copying the user-modifiable files includes copying them to multiple different logical drives that are specified by the metadata.

19. The method of claim 17, further comprising pre-analyzing the program prior to user execution in order to identify and distinguish the user-modifiable files from the user-independent files.

20. The method of claim 17, where the request is received from a remote computing device and includes a user-identification that is usable to distinguish between multiple different users of the device, to thereby select the user storage location that is associated with the user.
